(19) United States
(12) Patent Application Publication
(10) Pub. No.: US 2009/0301050 A1
(43) Pub. Date: Dec. 10, 2009

(54) LAWN MOWER ATTACHMENT AND METHOD

(76) Inventor: Gary Chester Kohler, Owings, MD (US)

Correspondence Address: William C. Schrot;EDELL, SHAPIRO & FINNAN, LLC, Suite 400, 1901 Research Boulevard, Rockville, MD, 20850, US

(21) Appl. No.: 12/136,264

(22) Filed: Jun. 10, 2008

(51) Int. Cl. A01D 75/00

(52) U.S. Cl. 56/320.2

(57) ABSTRACT

The present invention is directed to a lawn mower attachment for controlling lateral discharge of clippings expelled from a discharge chute of a mover. The attachment includes a flap pivotally connected to an exterior surface of a lawn mower proximate a discharge chute thereof. A support strut and a control bracket spaced therefore are connected to the exterior surface of the lawn mower. A shaft extends between the control bracket and the support strut. A linkage having a first end pivotally coupled to the shaft proximate the support strut and a second end pivotally coupled to the flap is provided. A distal edge of the flap is pivoted away from the discharge chute upon rotational movement about a longitudinal axis of the shaft in a first direction, and pivoted toward the discharge chute upon rotational movement in an opposite second direction.

### FIELD OF THE INVENTION

The present invention relates to a lawn mower attachment for controlling lateral discharge of clippings expelled from a discharge chute of a mover.

### BACKGROUND OF THE INVENTION

Conventional lawnmowers, including walk-behind and riding mowers, include a mower deck having one or more rotary cutting blades disposed therein. Grass clippings may be discharged out of one side of the mower deck via a discharge chute. If a mulching deck is provided, grass clippings may be re-cut into finer particles and then discharged directly down to the ground. Many conventional mowers may be converted from a side discharge mower to a mulching mower, and vice versa, by changing baffles provided on the deck and the type of blade.

Some conventional mower designs provide for flow control through mulching baffles that are attached to the underside of the mower deck. Mulching baffles maintain the clippings cut by the blade within an enclosed area around the blade so that the clippings are re-cut by the blade. However, installation or removal of such mulching baffles and mulching blades is time-consuming and labor intensive. Further, mulching baffles function to control the movement of air and clippings within the mower deck, as opposed to controlling lateral discharge of clippings from the discharge chute.

Other mower designs provide for a mulch plate or plug which covers the discharge chute. Some conventional mulch plates are bolted onto the discharge chute, thereby shielding the chute to redirect grass clippings back into the deck housing for recirculation. Other designs provide for a mulch plug which is inserted into the discharge chute. While such plugs may be more easily removed than other designs, the chute is completely blocked by the plug given the function of the plate or plug is to prohibit clippings from being discharged from the chute.

Still other mower designs include a moveable guide plate which may be pivoted into a first position for directing clippings out of the discharge chute, and a second position for directing clippings into an associated mower bag or other such receptacle. Such mower designs may be more easily switched from a side discharge mower to a mulching mower compared to other conventional mower designs. However, such designs fail to provide any control of lateral discharge of the clippings. Moreover, many such designs, in addition to the guide plate, also require a plug in the discharge chute when in the mulching mode.

Therefore, there is a need to provide a lawn mower attachment for controlling lateral discharge of clippings expelled from a discharge chute of mower, which may be easily adjusted by the operator. Further, there is a need for a lawn mower attachment that overcomes some or all of the above-noted problems.

### SUMMARY OF THE INVENTION

The present invention relates to a lawn mower attachment for controlling lateral discharge of clippings expelled from a discharge chute of a mover. A disclosed embodiment of the attachment includes a flap pivotally connected to an exterior surface of a lawn mower proximate a discharge chute thereof, a support strut connected to the exterior surface of the lawn mower, and a control bracket connected to the exterior surface of the lawn mower and spaced from the support strut. A shaft extends between the control bracket and the support strut. A linkage is provided having a first end pivotally coupled to the shaft proximate the support strut, and a second end pivotally coupled to the flap. A distal edge of the flap is pivoted away from the discharge chute by the second end of the linkage upon rotational movement about a longitudinal axis of the shaft in a first direction. The distal edge of the flap is pivoted toward the discharge chute by the second end of the linkage upon rotational movement about the longitudinal axis of the shaft in an opposite second direction.

### BRIEF DESCRIPTION OF THE FIGURES

FIG. 1 is a fragmentary perspective view of a lawn mower, and a mower attachment according to the present invention;

FIG. 2 is a fragmentary perspective view of the lawn mower and the mower attachment of FIG. 1 viewed from another direction;

FIG. 3 is a fragmentary perspective view of the lawn mower and the mower attachment of FIG. 2 showing the mower attachment in another orientation;

FIG. 4 is a fragmentary perspective view of a portion of the mower attachment of FIG. 1 and in a fully open position;

FIG. 5 is a fragmentary perspective view of the portion of the mower attachment shown in FIG. 4 viewed from another direction and in a fully closed position;

FIG. 6 is a fragmentary perspective view showing another portion of the mower attachment of FIG. 1; and

FIG. 7 is a fragmentary perspective view of a lawn mower and a portion of the mower attachment and guard according to the present invention.

### DETAILED DESCRIPTION OF PREFERRED EMBODIMENTS

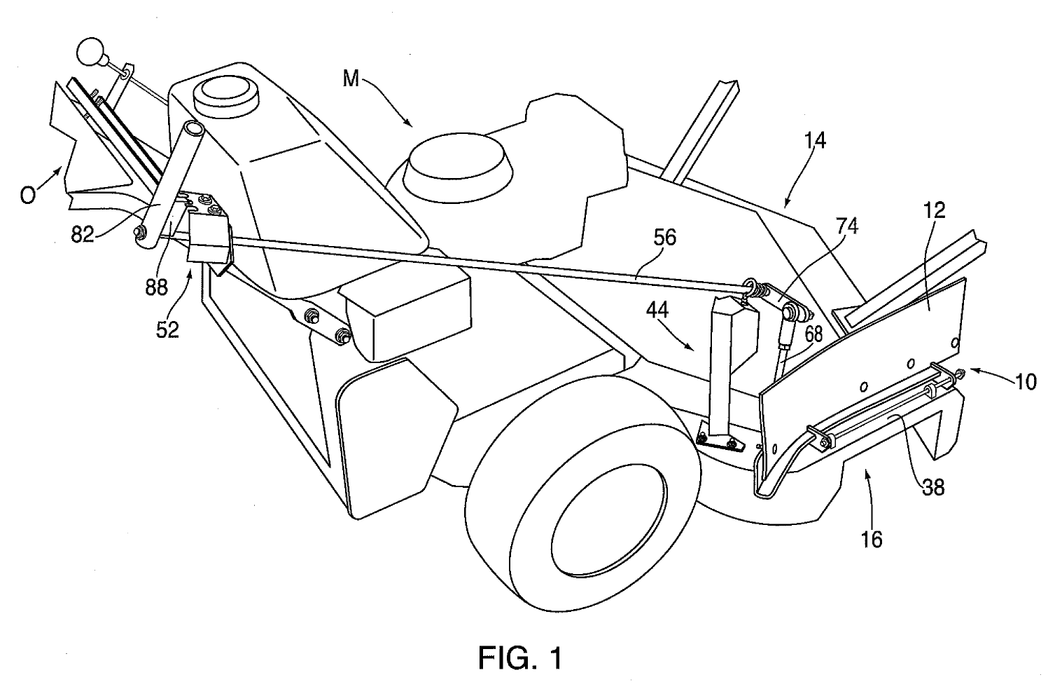

A lawn mower attachment 10 for controlling lateral discharge of clippings expelled from a discharge chute of a mower M according to an embodiment of the present invention is shown in FIGS. 1, 2 and 3. Attachment 10 includes a flap 12 pivotally attached to a deck 14 of mower M proximate a discharge chute 16 thereof, so that flap 12 is pivotally positionable over discharge chute 16.

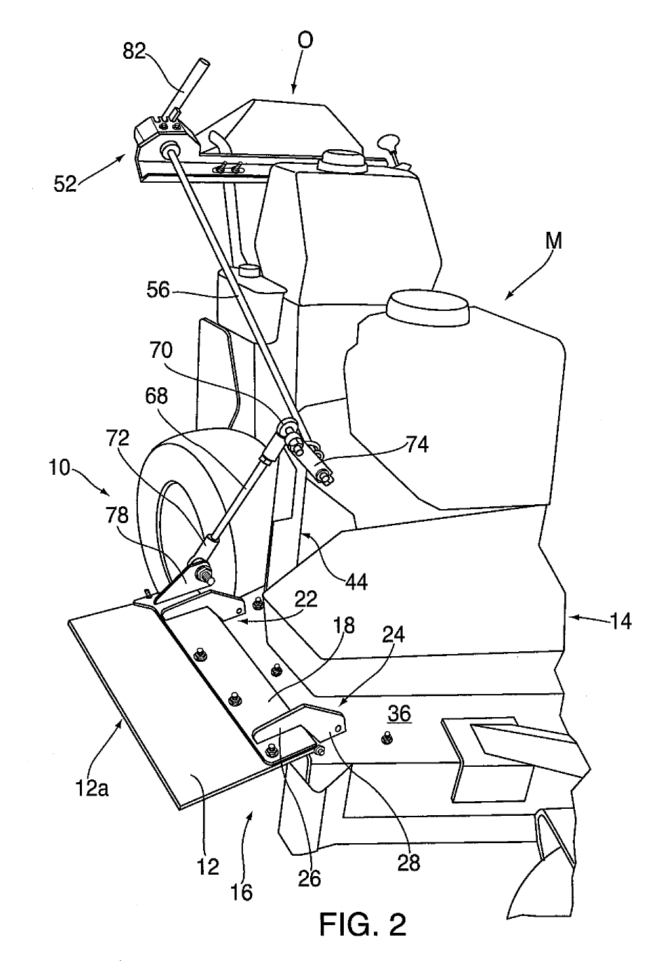

Referring to FIGS. 2, 4 and 5, a support plate 18 may be secured to a longitudinal edge of flap 12 via associated fasteners 20. Support plate 18 may include first and second flanges 22, 24 extending outwardly proximate opposite ends thereof. Each of flanges 22, 24 has a generally L-shaped inner edge having a first portion 26 proximate flap 12, and a second portion 28 proximate deck 14. Second portion 28 preferably includes one or more openings.

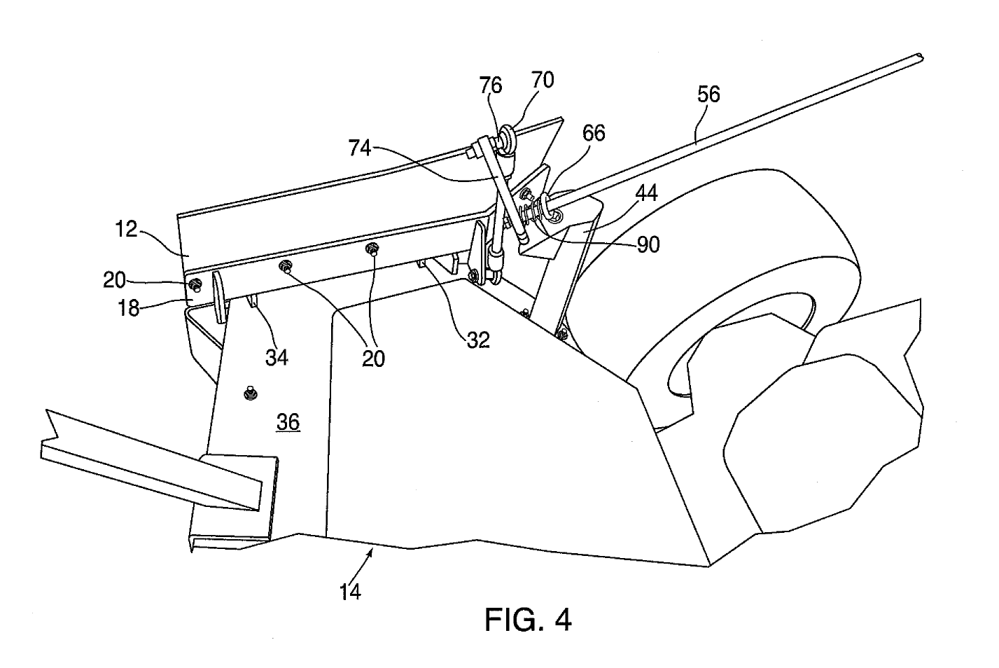

As best shown in FIGS. 4, 5 and 7, first and second spaced deck brackets 32, 34 are provided on mower M, which extend outwardly and upwardly from an upper surface 36 of deck 14. Each of deck brackets 32, 34 is proximate a corresponding end of an upper edge 38 of deck 14 defining discharge chute 16. Deck brackets 32, 34 include axially aligned holes. Support plate 18 is positioned proximate upper edge 38 such that the openings in each of second portions 28 of flanges 22, 24 is axially aligned with the holes in deck brackets 32, 34. A rod 40 extends through the axially aligned openings in flanges 22, 24 and holes in deck brackets 32, 34, such that support plate 18 and therefore flap 12 is pivotally secured to deck 14. Retaining nuts 42 may be provided on opposite ends of rod 40.

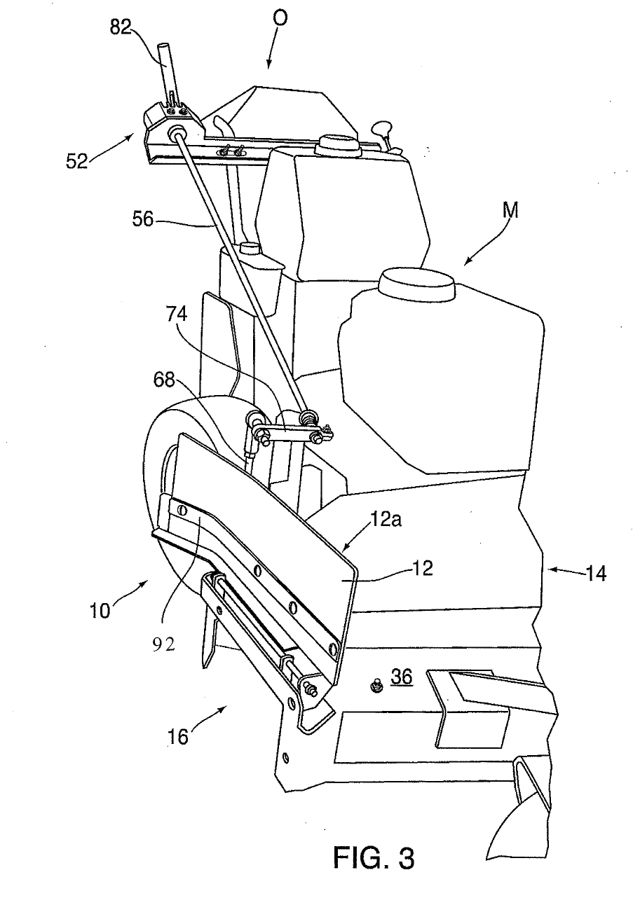

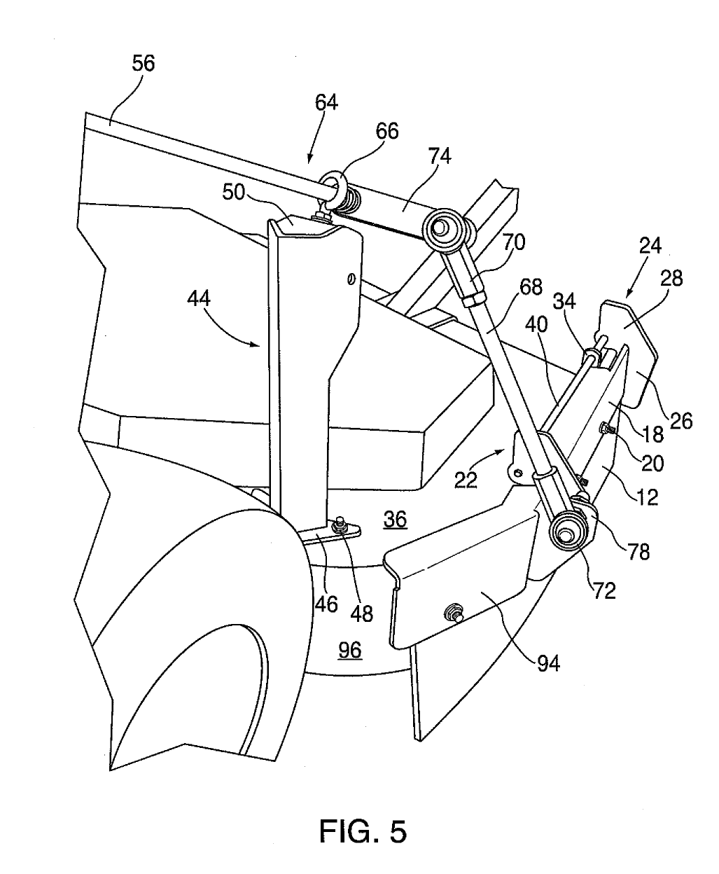

Support plate 18 is pivotally connected to upper surface 36 such that a distal edge 12a of flap 12 may be pivotally moveable toward or away from discharge chute 16, as shown in FIGS. 2 and 3. Flap 12 may be pivoted to a fully closed position as shown in FIG. 5, or to a fully open position as shown in FIGS. 1, 3 and 4, or to a partially open position as shown in FIG. 2.

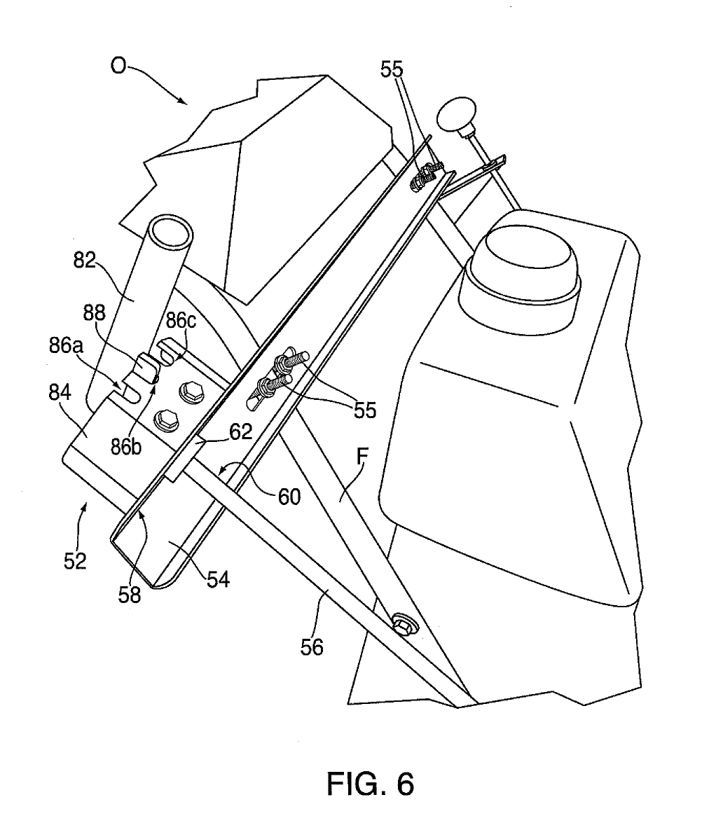

Referring to FIGS. 1, 5 and 6, a support strut 44 is provided, which includes a first end 46 secured to upper surface 36 of deck 14 via associated fasteners 48, and a second distal end 50. A control bracket 52 is connected to mower M and spaced from support strut 44. Preferably, control bracket 52 is proximate an operator's station O on mower M, which includes a plurality of handles and controls for controlling operation of the mower, as known in the art. Control bracket 52 may be supported by a crossbar 54, which is mounted to a frame F supporting the operator's station O, as shown in FIG. 6. Crossbar 54 is secured to steel tubing supporting the operator's station O via associated U-bolts and nuts 55. It would be readily apparent to one skilled in the art that crossbar 54 may be differently configured, or even unnecessary, for attaching control bracket 52 to mower M. However, control bracket 52 is preferably positioned on mower M within easy reach of an operator when operating mower M.

A shaft 56 extends between control bracket 52 and support strut 44. Preferably, control bracket 52 includes a base 58 having an opening through which one end 60 of shaft 56 extends. A collar 62 may be provided on base 58 which defines the opening and acts as a bearing allowing for smooth rotational movement of shaft 56 about its longitudinal axis, as well as linear movement of shaft 56 within the opening. Support strut 44 also preferably includes an opening through which an opposite end 64 of shaft 56 extends. The opening on support strut 44 may be formed by an eye bolt 66 secured to support strut 44, as shown in FIG. 5. Alternatively, some other suitable structure could be secured to support strut 44 which includes an opening for receiving shaft 56, or an opening could be provided in the metal stock forming support strut 44 for receiving shaft 56.

A linkage 68 is provided, which includes a first end 70 pivotally coupled to shaft 56 proximate support strut 44, and a second end 72 pivotally coupled to flap 12. In a preferred configuration, an arm 74 extends outwardly from end 64 of shaft 56. Arm 74 is preferably fixedly secured to end 64. Arm 74 and end 64 of shaft 56 may have an L-shaped configuration, wherein arm 74 is substantially perpendicular to shaft 56. First end 70 of linkage 68 may be pivotally connected to a distal end of arm 74 via a ball and socket joint, and thereby coupled to shaft 56. For example, first end 70 of linkage 68 may have a socket configuration. A pin 76 may be provided that has a first end secured to the distal end of arm 74, such as through a corresponding hole in arm 74 and with associated fasteners, as best shown in FIG. 4. Pin 76 includes a second end having a ball configuration which is rotatably retained within the socket configuration of first end 70 of linkage 68. In this way, first end 70 is coupled to arm 74 via a ball and socket joint, thereby allowing for limited rotational movement of linkage 68 relative to shaft 56.

Second end 72 of linkage 68 may be pivotally connected to an end bracket 78 extending outwardly from support plate 18, thereby pivotally coupled linkage 68 to flap 12, as shown in FIGS. 2, 5 and 7. End bracket 78 may extend outwardly from support plate 18 on a plane substantially perpendicular to the plane of flap 12. Second end 72 of linkage 68 may have a socket configuration, similar to first end 70. A pin 80 may be provided that has a first end secured to end bracket 78, such as through a corresponding hole in end bracket 78 and with associated fasteners. Similar to pin 76, pin 80 includes a second end having a ball configuration which is rotatably retained within the socket configuration of second end 72 of linkage 68. Thus, second end 72 is coupled to end bracket 78 via a ball and socket joint, which allows for limited rotational movement of linkage 68 relative to support plate 18. Specifically, as end bracket 78 on support plate 18 is pivoted from a closed position to an open position, the connection point between pin 80 and end bracket 78 proceeds along an arcuate path. The ball and socket coupling between second end 72 of linkage and end bracket 78 via pin 80 accounts for this arcuate motion, thereby permitting upward linear movement of linkage 68 which translates into pivotal movement of support plate 18.

When shaft 56 is rotated in a first direction about its longitudinal axis, e.g. counterclockwise rotational movement of shaft 56 relative to the operator's station O, arm 74 is thereby rotated. Linkage 68 is thereby pulled upwardly via the coupling between arm 74 and first end 70. Because of the rotational movement of arm 74 about the longitudinal axis of shaft 56, whereby the distal end of arm 74 subtends a certain angle of rotation, limited pivotal movement of linkage 68 is necessary in order to actuate linear movement thereof. This limited rotational movement is permitted due to the ball and socket joint between first end 70 and arm 74.

The linear and limited rotational movement of linkage 68 via rotation of shaft 56 thereby causes linkage 68 to pull distal edge 12a of flap 12 away from discharge chute 16. Due to the pivotal movement of distal edge 12a relative to discharge chute 12, limited pivotal movement of linkage 68 is necessary. This limited rotational movement is permitted due to the ball and socket joint between second end 72 and end bracket 78.

In this way, distal edge 12a of flap 12 may be pivoted away from discharge chute 16 by second end 72 of linkage 68 upon rotational movement about the longitudinal axis of shaft 56 in a first direction, for example counterclockwise rotation of shaft 56. Conversely, distal edge 12a may be pivoted toward discharge chute 16 by second end 72 of linkage 68 upon rotational movement about the longitudinal axis of shaft 56 in an opposite second direction, for example clockwise rotation of shaft 56.

Preferably, a handle 82 is provided proximate end 60 of shaft 56, which is proximate control bracket 52 and operator's station O. As such, handle 82 is within easy reach of the operator when operating mower M. Handle 82 is configured for being easily gripped by the operator for effectuating rotational movement of shaft 56. For example, handle 82 may be configured as a arm extending outwardly from end 60, such as a piece of steel tubing secured to end 60. Of course, various handle configurations are possible.

Control bracket 52 preferably includes a sidewall 84 extending upwardly from base 58, as shown in FIG. 6. Sidewall 84 includes a plurality of notches 86a, 86ab, 86c. A flange 88 extends axially outward from shaft 56 proximate end 60 thereof, and is configured for being removably retained within a selected one of notches 86a-c. In this way, shaft 56 may be releasably maintained at a selected rotational angle relative to the longitudinal axis thereof by aligning flange 88 with a selected one of notches 86a-c, thereby releasably locking distal edge 12a of flap 12 in a selected position relative to discharge chute 16.

Shaft 56 has a length sufficient to permit limited linear movement while being maintained between control bracket 52 and support strut 44. Preferably, end 64 of shaft 56 extends outwardly from support strut 44 and through eye bolt 66 a sufficient distance to allow shaft 56 to slide linearly toward operator's station O, while still extending between control bracket 52 and support strut 44. In a preferred embodiment, arm 74 is spaced from eye bolt 66 (or other opening) on support strut 44 a predetermined distance, as shown in FIG. 4. The operator may then pull handle 82 outwardly away from control bracket 52, thereby sliding shaft 56 upwardly. A sufficient spacing is provided between arm 74 and eye bolt 66 to allow for flange 88 to be pulled out of one of notches 86a-c. The operator may then rotate shaft 56 to another selected rotational angle, thereby pivoting flap 12 toward or away from discharge chute 16. By pushing handle 82 toward control bracket while aligning and retaining flange 88 in another of the notches 86a-c, flap 12 may then be retained in another selected position. Thus, shaft 56 is linearly moveable a predetermined distance for slidably moving flange 88 out of one of the plurality of notches 86a-c and into another of the plurality of notches 86a-c.

Preferably, a spring 90 is provided around shaft 56 and intermediate arm 74 and eye bolt 66, as shown in FIGS. 4 and 5. Spring 90 compresses as shaft 56 is slide upwardly, and thus biases flange 88 toward control bracket 52 and arm 74 away from support strut 44 after the operator has released handle 82. Arm 74 is thereby biased away from the opening in support strut 44 by the predetermined distance allowing linear movement of flange 88 out of one of the plurality of notches 86a-c. In addition, flange 88 is tensionably retained within the selected notch 86a-c via the outwardly biased force of spring 90 against arm 74. In this way, the possibility of flange 88 unintentionally sliding out of the selected notch 86a-c is minimized. However, the tension exerted by spring 90 is not so great such that the operator may not easily pull handle 82 outwardly and away from control bracket 52 in order to rotate shaft 56, and thereby adjust the angle of flap 12 relative to discharge chute 16.

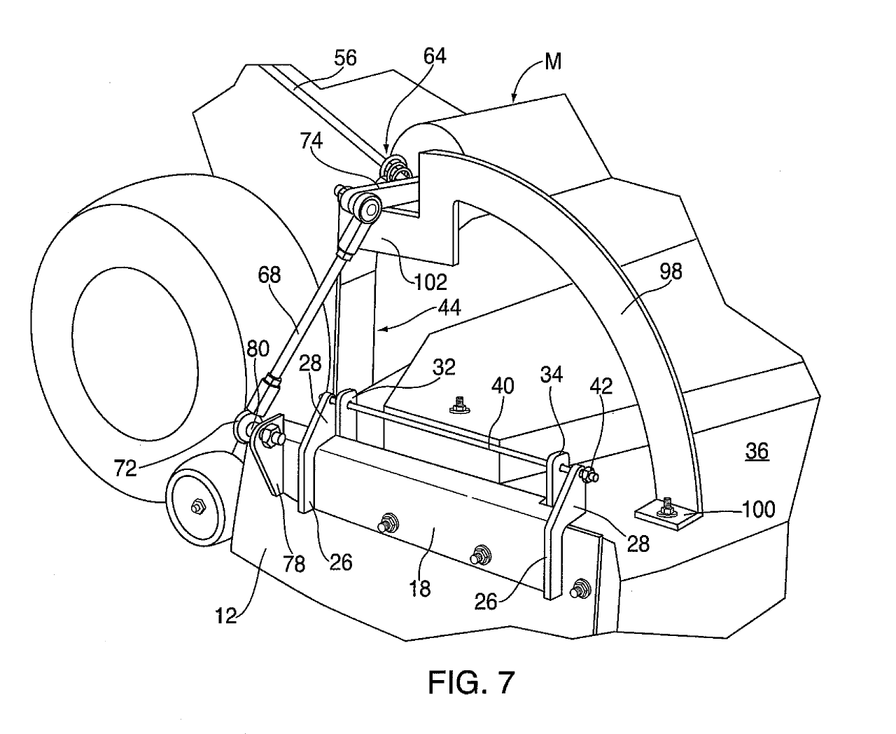

The coupling between shaft 56 and linkage 68 via arm 74, and between linkage 68 and support plate 18, allow the operator to pivot distal edge 12a of flap 12 to a filly open position as shown in FIGS. 1, 3 and 4, or to a fully closed position as shown in FIGS. 5 and 7, or to a position intermediate the fully open and filly closed positions as shown in FIG. 2. Preferably, distal edge 12a subtends an angle of at least about 90°, more preferably about 180°, between a fully closed position and a fully open position.

For example, alignment of flange 88 with notch 86c closest to operator's station O may be selected in order to releasably lock distal edge 12a of flap 12 in a position intermediate the fully open and fully closed positions, wherein distal edge 12a has subtended an angle of about 90° relative to the plane of discharge chute 16. Alignment of flange 88 with middle notch 86b may releasably lock distal edge 12a of flap 12 is in another position intermediate the fully open and fully closed positions, wherein distal edge 12a has subtended an angle of about 45° relative to the plane of discharge chute 16.

Alignment of flange 88 with notch 86a may releasably lock distal edge 12a of flap 12 in the fully closed position. Alternatively, distal edge 12a may be releasably locked in some other intermediate position when flange 88 is retained in notch 86a, in which case flange 88 may be disposed to the right of notch 86a away from operator's station O. Due to the weight of support plate 18, flap 12, and linkage 68, gravitational forces bias support plate 18 and linkage 68 downwardly. Thus, flap 12 is biased toward the fully closed position unless flange 88 is releasably locked in a selected position as described above. Of course, it would be readily apparent to one skilled in the art that fewer or more notches may be provided on control bracket 52 than described herein to provide additional positions in which flap 12 may be releasably locked. Therefore, the depiction and description of three notches 86a-c is for purposes of explanation only, and the disclosed invention is not so limited.

Upward movement of linkage 68 via rotation of shaft 56 in a first direction causes flap 12 to open. Downward movement of linkage 68 via rotation of shaft in an opposite second direction causes flap to close. However, the angular range of rotational movement of shaft 56 relative to its longitudinal axis is limited by the lengths of linkage 68 and arm 74. Therefore, in order to pivot flap 12 to its fully open position (e.g. more than 90° from the fully closed position, preferably about 180° from the fully closed position as described above), the operator first rotates handle 82 and thus shaft 56 in the first direction (e.g. a counterclockwise direction relative to the operator's station O) by applying a quick rotational burst of force, and then rotates handle 82 and thus shaft 56 in the opposite second direction (e.g. clockwise direction) also in a quick rotational movement.

When pivoting flap 12 to its fully open position, the momentum created by the weight of support plate 18 and flap 12, along with the initial quick rotational burst of force in the counterclockwise direction, causes support plate 18 to flip upwardly toward the fully open position. Support plate 18 is initially pulled upwardly by linkage 68 by the counterclockwise rotational movement of shaft 12. As noted above, as end bracket 78 on support plate 18 is pivoted from a closed position to an open position, the connection point between pin 80 and end bracket 78 proceeds along an arcuate path. The connection point reaches its apex along this arcuate path prior to support plate 18 reaching the fully open position, the position shown in FIG. 2. As support plate 18 proceeds to the fully open position, the connection point proceeds downwardly along the arcuate path toward deck 14. Therefore, linkage 68 and distal end of arm 74 also move linearly downward to allow the connection point to proceed downwardly along its arcuate path, the position shown in FIG. 3. In addition, the ball and socket connection between first end 70 of linkage 68 and arm 74, and the ball and socket connection between second end 72 of linkage 68 and end bracket 78, allow linkage 68 to continue pivoting as support plate 18 and thus flap 12 continue to pivot into the fully open position. In this way, distal edge 12a of flap 12 is able to subtend an angle of about 180° between the fully closed and fully open positions.

Comparing FIGS. 2 and 3, the distal end of arm 74 has been rotated in the second direction (e.g. clockwise direction relative to the operator), thereby moving linkage 68 downwardly. In this way, the connection point between pin 80 and end bracket 78 is permitted to continue along its arcuate path downwardly toward deck 14, until support plate 18 is disposed in the fully open position.

In order to rotate the distal end of arm 74 in the second direction and move linkage downwardly, the operator rotates handle 82 and thus shaft 56 in the second direction (e.g. a clockwise direction) by applying a rotational burst of force in the second direction following the first rotational burst of force in the first direction described above. Comparing FIG. 2 to FIG. 3, handle 82 and thus shaft 56 has been rotated in the second direction following the initial burst of rotational force in the first direction. This sequence of rotations, a quick rotational ‘snap’ in the first direction followed by a quick rotational thrust in the second direction, allows support plate 18 to easily move from a fully closed position to a fully open position. Moreover, the momentum created by the weight of support plate 18 and flap 12, initiated by the rotational thrusts, allows for a smooth operation for rotating the distal edge 12a of flap to the fully open position.

Attachment 10 allows the operator to selectively switch between a mulching mode when flap 12 is in a fully closed position, and discharging mode when flap 12 is in a fully open position. In addition, the operator may selectively adjust the lateral distance that the clippings are discharged from discharge chute 16 by adjusting the angle at which flap 12 is disposed relative to the plane of discharge chute 16 (and the ground). The operator may need to reduce the lateral distance that clippings are expelled from discharge chute 16, without having flap 12 completely blocking discharge chute 16. For example, if the operator is mowing an area which is close to a flower bed or fence, the operator may want to discharge clippings from discharge chute 16, but without expelling the clippings so far as to land within the flower bed or on the fence. In such a case, the operator may move flange 88 to a selected notch 86a-c via rotation of handle 82 and thus shaft 56. Flap 12 is thereby pivoted to a position corresponding to the selected angle of rotation. Grass clippings and other debris are thrown from discharge chute 16, but are deflected downwardly by flap 12, thereby reducing the lateral distance clippings are expelled from discharge chute 16.

As shown in FIG. 3, attachment 10 may include a bendable strap 92 secured to flap 12, such as a steel strap, which may be easily bent to a selected angle so that flap 12 conforms to the discharge chute 16. The bendable strap may be secured to either the outer or inner surface of flap 12 via associated fasteners or adhesive. Such a strap may be desirable if discharge chute 16 is rounded or includes portions not substantially planar. Alternatively, flap 12 may be formed of a bendable material, which may be bent by the user to conform to discharge chute 16.

Alternatively or in addition, a support plate extension 94 may be provided, which extends outwardly from an end of support plate 18, such as proximate end bracket 78, Support plate extension 94 may be angularly disposed relative to support plate 18 in order to conform to discharge chute 16 and/or the side of 96 of deck 14, as shown in FIG. 5. Of course, the precise configuration of support plate extension 94 may vary depending on the configuration of mower M and discharge chute 16.

As shown in FIG. 7, a guard 98 may be provided for deflecting braches or other objects away from support strut 44, and thus first end 70 of linkage 68, arm 74, and end 64 of shaft 56. Guard 98 may have an arcuate configuration, with a first end 100 secured to upper surface 36 of deck 14 proximate the front of mower M, and a second end 102 secured to support strut 44. Second end 102 of guard 98 may include an L-shape configuration so that second end 102 is attached to support strut 44 below end 64 of shaft 64, and then extends upwardly above end 64 of shaft 56 in order to deflect branches and debris therefrom. It would be readily apparent to one skilled in the art that the configuration of guard 98 may vary depending on the configuration of mower M and support strut 44.

It will be apparent to one of ordinary skill in the art that various modifications and variations can be made in construction or configuration of the present invention without departing from the scope or spirit of the invention. Although the present invention has been described with reference to figures showing a walk-behind mower, the lawn mower attachments disclosed herein could also be configured for attachment to a riding mower. Further, the specific configurations of the components, such as the support strut, control bracket, support plate and guard, disclosed herein are exemplary only, and the present invention is not so limited. It would be readily apparent to one skilled in the art that modifications of the specific configurations could be made while still achieving the desired function. Thus, it is intended that the present invention cover all such modifications and variations, and as may be applied to the central features set forth above.

1. A lawn mower attachment for controlling lateral discharge of clippings expelled from a discharge chute of a mover, comprising:
a flap pivotally connected to an exterior surface of a lawn mower proximate a discharge chute thereof;
a support strut connected to said exterior surface of the lawn mower, the support strut including a first opening;
a control bracket connected to said exterior surface of the lawn mower and spaced from said support strut, said control bracket including a second opening;
a shaft having a first end extending through the first opening and an opposite second end extending through the second opening, the shaft extending between said control bracket and said support strut;
a linkage having a first end pivotally and rotatably coupled to the first end of said shaft, and the linkage having an opposite second end pivotally and rotatably coupled to said flap, wherein a distal edge of said flap is pivoted away from said discharge chute upon rotational movement about a longitudinal axis of said shaft in a first direction, and said distal edge of said flap is pivoted toward said discharge chute upon rotational movement about said longitudinal axis of said shaft in an opposite second direction.

2. The lawn mower attachment of claim 1, further comprising an arm extending outwardly from said first end of said shaft, said first end of said linkage pivotally connected to a distal end of said arm.

3. The lawn mower attachment of claim 2, wherein said arm is substantially perpendicular to said shaft.

4. (canceled)

5. (canceled)

6. The lawn mower attachment of claim 1, further comprising a spring disposed around said shaft and intermediate said first opening and said first end of said shaft, wherein said first end is biased away from said first opening a predetermined distance via said spring.

7. (canceled)

8. The lawn mower attachment of claim 1, further comprising a support plate attached to a longitudinal edge of said flap opposite said distal edge thereof, said support plate pivotally connected to said exterior surface so that said flap is pivotally coupled thereto.

9. The lawn mower attachment of claim 8, wherein said support plate includes an end bracket extending outwardly therefrom, said second end of said linkage pivotally connected to said end bracket via a ball and socket connector.

10. (canceled)

11. The lawn mower attachment of claim 1, further comprising a bendable strap secured to said flap and bendable to a selected angle so that said flap conforms to said discharge chute.

12. (canceled)

13. The lawn mower attachment of claim 1, wherein said control bracket includes a sidewall having a plurality of notches, and said shaft includes a flange extending axially outward and removably retained within a selected one of said plurality of notches so that said shaft is disposed at a selected rotational angle, thereby maintaining said distal edge of said flap in a selected position relative to said discharge chute.

14. The lawn mower attachment of claim 13, wherein said second end of said shaft is linearly moveable a predetermined distance along a path coaxial with the longitudinal axis thereof for slidably moving said flange out of one of said plurality of notches and into another of said plurality of notches.

15. The lawn mower attachment of claim 1, wherein said distal edge of said flap subtends an angle of at least about 90° between a fully closed position and a fully open position.

16. (canceled)

17. (canceled)

18. (canceled)

19. (canceled)

20. The lawn mower attachment of claim 1, further comprising a guard having a first end secured to said support strut and a second end secured to said exterior surface of said mower proximate a front deck portion thereof.

21. A lawn mower and attachment, comprising:
a lawn mower including a deck defining a discharge chute, an operator's station for controlling operation of the lawn mower, and a frame having a first portion coupled to the deck and an opposite second portion supporting the operator's station;
a flap pivotally connected to the deck proximate the discharge chute;
a support strut connected to the deck, the support strut including a first opening;
a control bracket connected to the frame proximate the operator's station, the control bracket including a second opening;
a shaft having a first end extending through the first opening and a second end extending through the second opening, the shaft extending between the control bracket and the support strut;
a linkage having a first end coupled to the first end of the shaft and an opposite second end coupled to the flap, wherein a distal edge of the flap is pivoted away from the discharge chute upon rotational movement about a longitudinal axis of the shaft in a first direction, and the distal edge of the flap is pivoted toward the discharge chute upon rotational movement about the longitudinal axis of the shaft in an opposite second direction.

22. The lawn mower and attachment of claim 21, wherein the first end of the linkage is pivotally and rotatably coupled to the first end of the shaft and the second end of the linkage is pivotally and rotatably coupled to the flap.

23. The lawn mower and attachment of claim 21, wherein the first end of the shaft is linearly moveable toward and away from the control bracket along a path coaxial with the longitudinal axis thereof and between a first position and a second position, and rotational movement of the shaft is permitted when the second end of the shaft is disposed in the first position and rotational movement of the shaft is restricted when the second end of the shaft is disposed in the second position.

24. An attachment for a lawn mower comprising:
a flap pivotally connected to a deck of a lawn mower proximate a discharge chute thereof;
a control bracket connected to a frame of the lawn mower and proximate an operator's station thereof, the frame having a first portion coupled to the deck and an opposite second portion supporting the operator's station;
a shaft having a first end extending through an opening in the control bracket, and an opposite second end coupled to the flap, the shaft rotatable in a first direction and an opposite second direction about a longitudinal axis thereof, and the first end of the shaft linearly moveable toward and away from the control bracket along a path coaxial with the longitudinal axis thereof,
wherein a distal edge of the flap is pivoted away from the discharge chute upon rotational movement about a longitudinal axis of the shaft in a first direction, and the distal edge of the flap is pivoted toward the discharge chute upon rotational movement about the longitudinal axis of the shaft in an opposite second direction.

25. The attachment of claim 24, wherein the second end of the shaft is linearly moveable toward and away from the control bracket between a first position and a second position, and rotational movement of the shaft is permitted when the second end of the shaft is disposed in the first position and rotational movement of the shaft is restricted when the second end of the shaft is disposed in the second position.

26. The attachment of claim 25, wherein the control bracket includes a sidewall having a plurality of notches, and the second end of the shaft includes an axially extending flange removably retained within a selected one of the plurality of notches when the second end of the shaft is disposed in the second position, thereby maintaining the distal edge of the flap in a selected position relative to the discharge chute.

27. The attachment of claim 24, further comprising a linkage having a first end pivotally and rotatably coupled to the first end of the shaft, and the linkage having an opposite second end pivotally and rotatably coupled to the flap.

28. The attachment of claim 24, further comprising a support strut connected to the deck and supporting the second end of the shaft, the support strut including an opening through which the second end of the shaft extends.

29. The lawn mower attachment of claim 24, wherein the distal edge of the flap subtends an angle of about 180° between a fully closed position and a fully open position.
